(19) United States
(12) Patent Application Publication
(10) Pub. No.: US 2018/0159722 A1
(43) Pub. Date: Jun. 7, 2018

(54) DYNAMICALLY COMPOSED NETWORK RESOURCES METHOD AND APPARATUS

(71) Applicant: Intel Corporation, Santa Clara, CA (US)

(72) Inventors: Deepak Soma Reddy, Bangalore (IN); Mrittika Ganguli, Bangalore (IN); Mohan J. Kumar, Aloha, OR (US)

(21) Appl. No.: 15/370,563

(22) Filed: Dec. 6, 2016

(51) Int. Cl. H04L 12/24

(52) U.S. Cl. CPC H04L 41/046; H04L 41/0803; H04L 41/044

(57) ABSTRACT

Apparatus and method to dynamically compose network resources are disclosed herein. In some embodiments, a network management fabric controller may include a module, in response to a request for a network service, that is to identify a child pool included in a particular network service pool, from among a plurality of network service pools associated with respective network services, that is capable of providing the network service, the child pool comprising identification of one or more particular ports of a particular compute node switch within the network; and another module that is to establish a connection between a compute component and the one or more particular ports of the particular compute node switch and between the one or more particular ports of the particular compute node switch and one or more particular ports of the main network switch in accordance with the particular network service pool.

### FIELD OF THE INVENTION

The present disclosure relates generally to the technical fields of computing and networks, and more particularly, to provisioning network services.

### BACKGROUND

The background description provided herein is for the purpose of generally presenting the context of the disclosure. Unless otherwise indicated herein, the materials described in this section are not prior art to the claims in this application and are not admitted to be prior art or suggestions of the prior art, by inclusion in this section.

A data center network may include a main switch, also referred to as a top of the rack (TOR) switch, which may enable the network service elements (e.g., compute nodes) of the network. The network service elements may be statically composed or connected within the network during network setup or configuration. Each network service element may be connected to a particular port of the main switch, either directly or indirectly via one or more intervening network service elements.

Although such architecture may permit the main switch to control all the network service elements, the reliance on the main switch introduces network delays, particularly for network service elements that may require traversal of intervening network service element(s) to communicate with the main switch. The resources of the network may also be under-utilized, for example, where ports of the main switch connected to network service elements not in use may not be used for providing other needed services because of the static connection. Changes to network service elements, such as the addition of more network service elements to the network, may not be easily implemented without manual reconfiguration and setup.

### BRIEF DESCRIPTION OF THE DRAWINGS

Embodiments will be readily understood by the following detailed description in conjunction with the accompanying drawings. The concepts described herein are illustrated by way of example and not by way of limitation in the accompanying figures. For simplicity and clarity of illustration, elements illustrated in the figures are not necessarily drawn to scale. Where considered appropriate, like reference labels designate corresponding or analogous elements.

FIG. 1 depicts a block diagram illustrating a network view of an example system incorporated with the dynamic provisioning network services technology of the present disclosure, according to some embodiments.

FIG. 2 depicts an example block diagram illustrating a logical view of the system of FIG. 1, the block diagram illustrating algorithmic structures and data associated with the processes performed by the algorithmic structures, according to some embodiments.

FIG. 3 depicts an example process that may be performed by a controller and/or plug-in to manage de-centralized network service fulfillment, according to some embodiments.

FIG. 4 depicts an example process that may be performed by node switches and/or plug-ins to discover a registered compute component and to perform de-centralized network service fulfillment, according to some embodiments.

FIG. 5 shows example depictions of different models of DHCP network service pools, according to some embodiments.

FIG. 6 illustrates an example computer device suitable for use to practice aspects of the present disclosure, according to some embodiments.

FIG. 7 illustrates an example non-transitory computer-readable storage media having instructions configured to practice all or selected ones of the operations associated with the processes described herein, according to some embodiments.

### DETAILED DESCRIPTION

Embodiments of apparatuses and methods related to dynamically composed network resources are described. In some embodiments, a network management fabric controller may include a first module that is to register and configure a compute component capable of providing a network service within a network without association to a main network switch or any compute node switches of the network; a second module, in response to a request for the network service, that is to identify a child pool included in a particular network service pool, from among a plurality of network service pools associated with respective network services, that is capable of providing the network service, the child pool comprising identification of one or more particular ports of a particular compute node switch within the network; and a third module that is to establish a connection between the compute component and the one or more particular ports of the particular compute node switch and between the one or more particular ports of the particular compute node switch and one or more particular ports of the main network switch in accordance with the particular network service pool. These and other aspects of the present disclosure will be more fully described below.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device). As used herein, the term “logic” and “module” may refer to, be part of, or include an application specific integrated circuit (ASIC), an electronic circuit, a processor (shared, dedicated, or group), and/or memory (shared, dedicated, or group) that execute one or more software or firmware programs having machine instructions (generated from an assembler and/or a compiler), a combinational logic circuit, and/or other suitable components that provide the described functionality.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

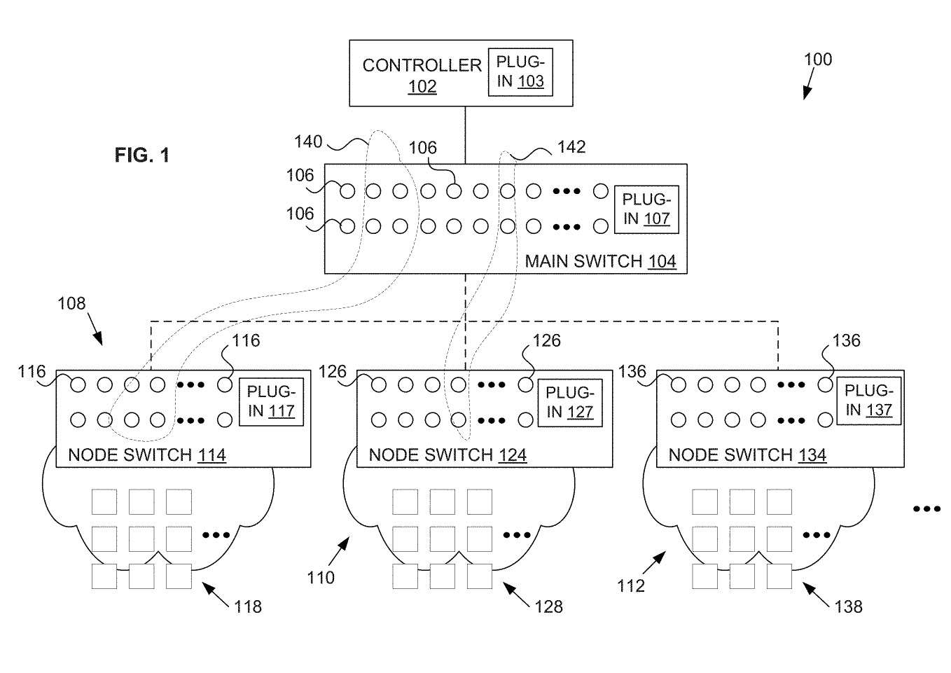

FIG. 1 depicts a block diagram illustrating a network view of an example system 100 incorporated with the dynamic provisioning network services technology of the present disclosure, according to some embodiments. System 100 may comprise a computing network, a data center, a computing fabric, and the like. In some embodiments, system 100 may include a controller 102, a main switch 104, and a plurality of compute node pools 108, 110, 112. Main switch 104 may communicate with each of the controller 102 and compute node pools 108, 110, 112.

Controller 102 may comprise one or more network management controllers for the system 100. Controller 102 may also be referred to a network management fabric controller or a fabric controller. Controller 102 may comprise one or more servers and/or include one or more storage mediums and one or more processors. As described more fully below, controller 102 may work in conjunction with the main switch 104 to dynamically compose, provision, and manage de-centralized network services offered by the compute node pools 108, 110, 112. Among other things, controller 102 may maintain information about the compute node pools 108, 110, 112, such as, but not limited to, the network service capabilities of each of the compute node pools 108, 110, 112 and the configuration settings to enable each of a plurality of network services.

Main switch 104 may comprise one or more top of the rack (TOR) switches for the system 100. Main switch 104 may also be referred to as a network switch, a system switch, a parent switch, a controller switch, a disaggregated switch, a main network switch, or the like. In some embodiments, main switch 104 may include a plurality of ports 106, a plug-in 107, and optionally, one or more other components such as a memory and/or a processor (not shown). The plurality of ports 106 may be connected to respective ports associated with the compute node pools 108, 110, 112, as described more fully below. The plurality of ports 106 may be enabled or disabled dynamically at runtime in accordance with the dynamic provisioning of network services. In some embodiments, each port of the plurality of ports 106 may be associated with a unique Internet protocol (IP) address. Plug-in 107, also referred to as a dynamic provisioning component, may comprise hardware, firmware, software, an application, app, circuitry, and/or the like to facilitate dynamic provisioning of network services of the present disclosure. For example plug-in 107 may be involved in tracking the status of ports 106 (e.g., active, inactive, healthy), configuration of pools for respective network services, disaster recovery, failover, and/or the like.

In some embodiments, a plug-in 103 may be included in the controller 102 to facilitate the dynamic provisioning technique of the present disclosure. Plug-in 103 may be similar to plug-in 107 or complementary to the plug-in 107. Plug-in 103 may comprise hardware, firmware, software, an application, app, circuitry, and/or the like. In other embodiments, plug-in 103 may be optional.

Compute node pool 108 may comprise a set/collection of one or more compute nodes, in which each compute node (also referred to as a node) comprises a sub-system or construct capable of performing a particular function, such as a particular network service. Each compute node may include one or more compute components such as, but not limited to, servers, processors, memory, routers, switches, gateways, relays, repeaters, and/or the like configured to provide a particular network service. Examples of network services include, but are not limited to, dynamic host configuration protocol (DHCP) network service, link layer discovery protocol (LLDP) network service, secure shell (SSH) network service, virtual local area network (VLAN) network service, and the like. A compute node may comprise a physical compute node, in which its compute components may be located proximate to each other, or a logical compute node, in which its compute components may be distributed geographically from each other such as in cloud computing environments. Compute node pool 108 may also be referred to as a compute node set. Likewise, compute node pool 108 may comprise a physical compute node pool or a logical compute node pool.

In some embodiments, compute node pool 108 may be associated with one or more node switches, such as a node switch 114, and a plurality of compute components 118 associated with the respective compute node(s) of the compute node pool 108. Node switch 114 may also be referred to as a child switch, a local switch, or the like. In some embodiments, node switch 114 may include a plurality of ports 116, a plug-in 117, and optionally, one or more other components such as a memory and/or a processor (not shown). The plurality of ports 116 may be connected to particular ones of the ports 106 of main switch 104, thereby providing a communication pathway between the main switch 104 and particular ones of the compute components 118. Plug-in 117 may comprise hardware, firmware, software, an application, an app, circuitry, and/or the like to facilitate dynamic provisioning of network services. In some embodiments, plug-in 117 may be similar to plug-in 107.

The plurality of compute components 118 may comprise, but not limited to, servers, processors, memory, routers, switches, and/or the like configured to provide certain network services associated with the compute nodes within the compute node pool 108. Although not shown in FIG. 1, compute components 118 may connect to the node switch 114, and the ports 116 of the node switch 114, in turn, may connect to ports 106 of the main switch 104. One or more of the compute components of the plurality of compute components 118 may be geographically proximate to each other (e.g., located together in the same rack, located in the same floor, located in the same building) or geographically distributed from each other (e.g., located in different buildings, located in different states, cloud computing environment). In some embodiments, compute components 118 may be referred to as network service resources.

In some embodiments, compute node pools 110 and 112 may be similar to compute node pool 108, except that the compute nodes included in the respective compute node pools 110, 112 may provide different network services than those of the compute nodes of the compute node pool 108. Compute node pool 110 may include a node switch 124 and a plurality of compute components 128. The node switch 124 may include a plurality of ports 126, a plug-in 127, and optionally one or more other components (not shown). Compute node pool 112 may include a node switch 134 and a plurality of compute components 138. The node switch 134 may include a plurality of ports 136, a plug-in 137, optionally one or more other components (not shown). Node switches 124, 134 may be similar to node switch 114; and compute components 128, 138 may be similar to compute components 118.

In some embodiments, compute node pools 108, 110, 112 may also include, without limitation, routers, switches, relays, processors, memory, and/or other components suitable to form a dynamic fabric or interconnections between and among compute components 118, 128, 138; node switches 114, 124, 134; and/or main switch 104, which in turn, may be selectively enabled, turned on, and/or otherwise established to “attach” the appropriate compute component(s) or compute node(s) to a node switch and the main switch in accordance with the network service pool allocation.

Although three compute node pools are shown in FIG. 1, it is contemplated that more than three compute node pools may be included in system 100. For example, hundreds or thousands of compute node pools may be included in system 100.

In embodiments of the present disclosure, components of the system 100 that are to provide one or more network services may be dynamically composed and provisioned at runtime using a software defined network (SDN) framework. Rather than statically assigning particular port(s) 106 of the main switch 104 to particular port(s) 116 of the node switch 114 (or port(s) 126 of the node switch 124 or port(s) 136 of the node switch 134) to provide a particular network service, they may be dynamically “attached” together at runtime based on the current needs/state of the system 100. In some embodiments, a plurality of network service pools may be allocated or designated, in which each network service pool of the plurality of network service pools may be associated with a particular network service. A network service pool (also referred to as a pool or a network service provisioning set) may be comprised of a parent pool that identifies particular port(s) of the main switch 104, a child pool that identifies particular port(s) of one or more of the node switches 114, 124, 134, and one or more of compute components 118, 128, 138 (or compute node(s) associated with set(s) of compute components). Since the child pool (or the particular port(s) of the one or more of the node switches 114, 124, 134) may be enabled with particular compute components 118, 128, 138 in order to fulfill the network service associated with the evoked network service pool, the combination of the child pool and relevant compute components may be referred to as a local network service pool, child network service pool, local pool of network service, child pool of network service, or the like.

For instance, FIG. 1 shows a depiction of an example network service pool 140, which may designate four particular ports 106 of the main switch 104 (e.g., the parent pool) and four particular ports 116 of the node switch 114 (e.g., the child pool). As such, the network service associated with the example network service pool 140 may be provided by one or more of the compute components 118, 128, 138 comprising the physical or logical compute node capable of providing the network service. For example network service pool 142, two particular ports 106 of the main switch 104 and two particular ports 126 of node switch 124 may be provisioned together to provide a certain network service. Hundreds, thousands, or more of such network service pools may be dynamically assigned or composed for the system 100. As compute components are added, deleted, or changed, certain components become non-operational, and/or other changes occur to capabilities of the system 100, new and/or different network service pools may be composed. For example, example network service pool 140 may be eliminated and/or example network service pool 142 may be modified accordingly. Further, while for ease of understanding, example network service pool 140 or 142 are illustrated with compute components 118 or 128 of compute node pools 108 or 110 and ports 116 or 126 of node switches 114 or 124, the present disclosure is not so limited. In general, a network service pool may include any number ports from any number of node switches, any number of ports from main switch 104, and any number of compute components, compute nodes, and/or compute node pools.

In some embodiments, any of plug-ins 103, 107, 117, 127, and/or 137 (or a portion thereof) may be implemented as software comprising one or more instructions to be executed by one or more processors included in the same respective system component with the one or more instructions (e.g., plug-in 107 implemented as one or more instructions to be executed by one or more processors included in the main switch 104). In some embodiments, the one or more instructions comprising the plug-ins 103, 107, 117, 127, and/or 137 may be stored and/or executed in a trusted execution environment (TEE) of the respective system components. In some embodiments, the TEE may be included in a dedicated core of respective system components. In alternative embodiments, the plug-ins 103, 107, 117, 127, and/or 137 (or a portion thereof) may be implemented as firmware or hardware such as, but not limited, to, an application specific integrated circuit (ASIC), programmable array logic (PAL), field programmable gate array (FPGA), and the like included in the respective system components.

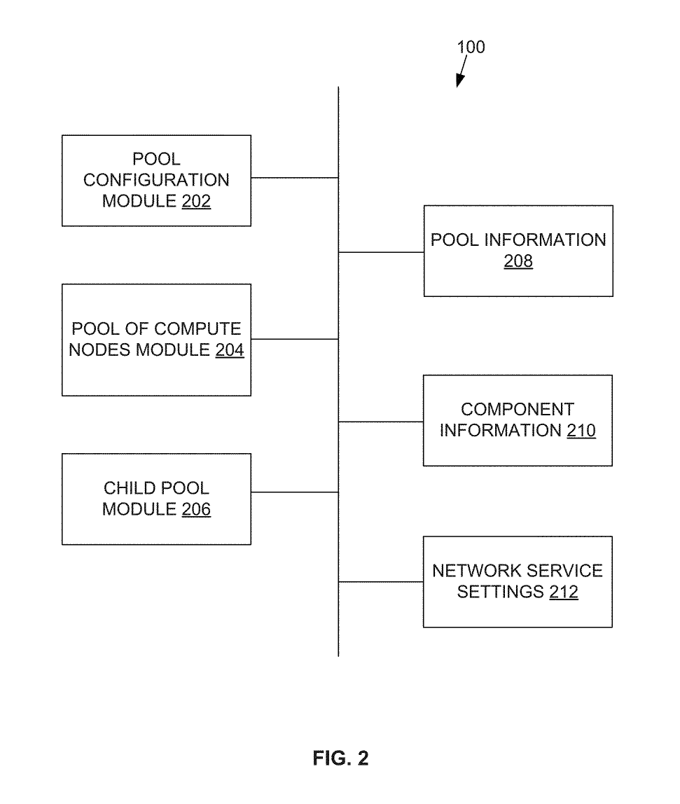

FIG. 2 depicts an example block diagram illustrating a logical view of the system 100, the block diagram illustrating algorithmic structures and data associated with the processes performed by the algorithmic structures, according to some embodiments. FIG. 2 illustrates example modules and data that may be included in and/or used by the controller 102, main switch 104, node switch 114, node switch 124, node switch 134, plug-in 103, plug-in 107, plug-in 117, plug-in 127, and/or plug-in 137 to provide dynamic provisioning of network services, according to some embodiments. In embodiments, these modules may include pool configuration module 202, pool of compute nodes module 204, and child pool module 206 having associated pool information 208, component information 210 and network service setting 212.

The various modules and/or data shown in FIG. 2 may be implemented at least partially by hardware at one or more computing devices, such as one or more hardware processors executing instructions stored in one or more memories for performing various functions described herein. The modules and/or data may be communicatively coupled (e.g., via appropriate interfaces) to each other and to various data sources, so as to allow information to be passed between the modules and/or to share and access common data. FIG. 2 illustrates only one of many possible arrangements of modules and data configured to perform the functionalities described herein. Other arrangements may include fewer or different modules and/or data, and the division of work between the modules and/or data may vary depending on the arrangement. In some embodiments, modules 202-206 may comprise one or more software components, programs, applications, or other units of code base or instructions configured to be executed by one or more processors, or may comprise one or more firmware or hardware components or circuitry, included in the controller 102, main switch 104, node switch 114, node switch 124, and/or node switch 134. Although modules 202-206 may be depicted as distinct components in FIG. 2, modules 202-206 may be implemented as fewer or more components than illustrated.

In some embodiments, pool configuration module 202 may be configured to determine the existence and/or status of child pools and parent pools, which in different combinations may comprise a plurality of network service pools. And when a child pool, parent pool, and/or network service pool in accordance with the desired network service may not already have been composed, provisioned, and/or configured, the pool configuration module 202 may dynamically compose, provision, and/or configure such child pool, parent pool, and/or network service pool. Information about existing child pools, parent pools, and/or network service pools may comprise the pool information 208.

The pool of compute nodes module 204 may be configured to perform registration, turning on, turning off, administrative, and/or other functions associated with setting up pools of compute nodes (or compute components) in the system 100, according to some embodiments. Module 204 may access component information 210 to perform such functions. Component information 210 may include, without limitation, information associated with pools of compute nodes already included in the system 100 and those to be included in the system 100. For example, the capabilities of each compute component included in a given pool of compute node may be included in the component information 210.

For a network service request, once the associated child pool, parent pool, network service pool, compute component(s), and pool of compute node(s) have been determined, setup, and otherwise ready to service the request, the child pool module 206 may be configured to determine (or perform a final check of) the status of child pool(s) (e.g., existence, availability, etc.) which are to be used to respond to the network service request, according to some embodiments. When a child pool to be used may not be available to service the network service request, then the child pool module 206 may be configured to search for another child pool that may service the request.

With a particular network service pool ready to service the network service request (which may include the pool configuration module 202 providing settings data associated with the network service requested from the network service settings 212 to the node switch associated with the pool of compute node that is to service the request), control functions associated with performing the network service request may transfer from the controller 102 and/or main switch 104 to the local level, e.g., the particular pool of compute node that is to service the request. Controller 102 and/or main switch 104 may not need to be involved in order to service the request until and unless the particular pool of compute node communicates a need to the main switch 104.

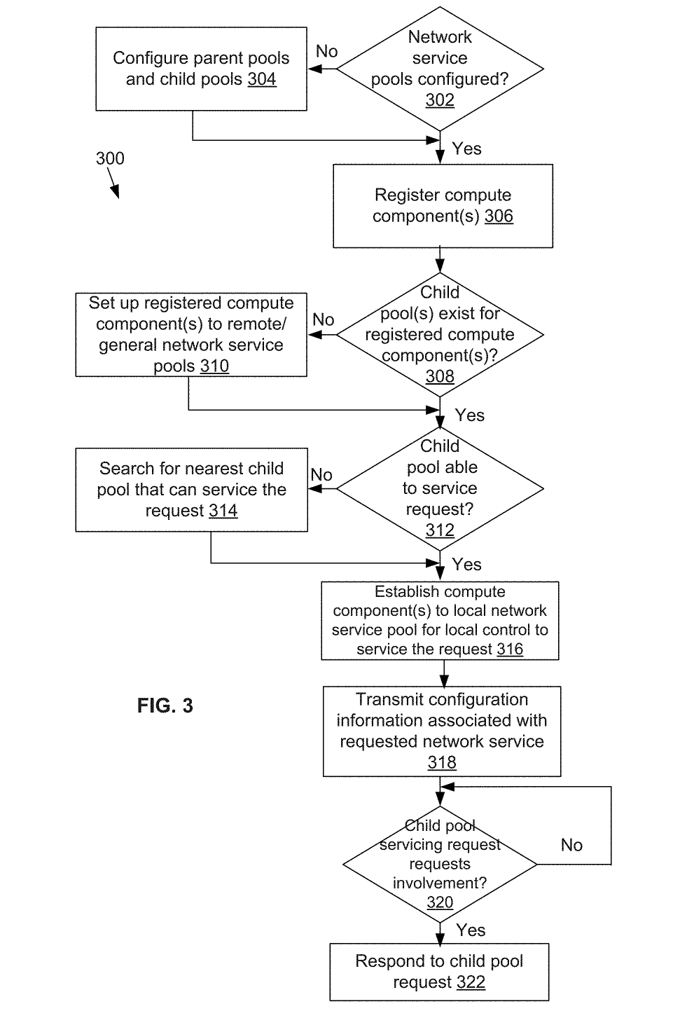

FIG. 3 depicts an example process 300 that may be performed by controller 102 and/or plug-in 103 to manage de-centralized network service fulfillment, according to some embodiments.

At a block 302, the pool configuration module 202 included in the controller 102 and/or plug-in 103 may determine whether network service pools associated with network services for the system 100 have been configured. Pool configuration module 202 may access the pool information 208 to determine whether allocation, designation, or specification regarding the network service pools exists. For instance, if a network service pool has already been configured, the pool information 208 associated therewith may include at least one parent pool (e.g., a set of identifiers of particular port(s) 106 of main switch 104), at least one child pool (e.g., a set of identifiers of particular port(s) of node switch 114, 124, and/or 134), and a network service identifier. Network service pools 140 and 142 shown in FIG. 1 may be examples of network service pool configurations.

If the network service pools have not been configured (no branch of block 302), then the pool configuration module 202 may configure or determine the parent pools and child pools to configure respective network service pools, at a block 304. In some embodiments, the pool configuration module 202 may access the component information 210 to obtain, for example, information about capabilities of the compute components 118, 128, 128 and/or node switches 114, 124, 134 so as to determine which node switches, pools of compute nodes, and/or ports of node switches may be capable of or otherwise support (e.g., taking into account factors such as load balancing or acceptable delay) performing respective network services corresponding to network service pools to be configured.

In some embodiments, a network service pool may be configured with a certain amount of flexibility or future needs in mind. As an example, a network service pool may be configured with four ports of the main switch 104 and four ports of node switches 114, 124, and/or 134. Hence, up to four compute nodes may be connected and operational in the network service pool. Nevertheless, less than all of the provisioned ports may be in use/occupied and the number and/or which of the four ports may be in use may also change over time. If, for instance, only two of the four ports are currently in use/occupied, then a request for a network service of the same type as associated with this network service pool arises, one of the unoccupied remaining two ports may now be put to use to service the latest request without having to configure a new network service pool.

If the network service pools may already be configured (yes branch of block 302) or after completion of block 304, then process 300 may proceed to block 306, in which compute components which are not already registered and known by the system 100 may be registered. The pool of compute nodes module 204 may be configured to facilitate registration of one or more such compute components. Registration information associated with each such compute component may be added to the component information 210, such as the compute component's model, make, and serial number and its specification or capabilities. A compute component may need to be registered because it is a new compute component being added to the system 100. In some embodiments, a compute component may be referred to as a drawer, blade, or resource.

Next at a block 308, the pool of compute nodes module 204 may be configured to determine whether a child pool exists (from among the plurality of network service pools that exist) for respective compute components that have been registered in block 306. The “matching” child pool may be the child pool associated with the same network service as the respective compute component that has been registered. If no child pool exists (no branch of block 308), then the pool of compute nodes module 204 may be configured to set up, configure, or otherwise establish these registered compute components to remote or general network service pools, at a block 310. Such remote or general network service pools may comprise provisionally “attaching” these registered compute components to pools of generally available compute components without association to the main switch 104 or any compute node switches (node switches 114, 124, 134).

Upon completion of block 310 or if child pools exist (yes branch of block 308), then process 300 may proceed to block 312. Child pool module 206 may be configured to determine or identify whether a child pool is able to service a particular network service request. The child pool of interest may be associated with the same network service as that specified in the network service request. In some embodiments, a plug-in associated with the child pool of interest may provide status information about the child pool to the main switch 104. For example, if the child pool of interest is associated with network service pool 140 (see FIG. 1), then plug-in 117 may track whether the node switch 114 and/or the particular port(s) of the child pool of interest may be unavailable, available, damaged, experiencing above threshold delays, offline, or other status information.

When the child pool of interest may not be available (no branch of block 312), then the child pool module 206 may be configured to search for the nearest another child pool that may service the network service request, at a block 314. As with the status information provided about the child pool of interest in block 312, plug-ins associated with respective one or more of the other child pools may report status information to the main switch 104, from which the nearest another child pool may be selected. Upon identification of the nearest another child pool, process 300 may proceed to block 314.

When a particular child pool (either the child pool of interest of block 312 or the nearest another child pool of block 314) may be available to service the network service request (yes branch of block 312), the child pool module 206 may establish a connection, turn on, or “attach” the relevant compute component(s) (those component(s) capable of providing the network service) to the particular child pool, thereby dynamically forming a local network service pool to fulfill the network service request, at a block 316.

Next, at a block 318, parent pool configuration information associated with the requested network service may be transmitted to the node switch associated with the particular child pool. In some embodiments, parent pool configuration information may comprise a configuration file associated with the particular network service for the particular port(s) of the main switch 104, and which may be maintained in the network service setting 212. The same configuration file as used in the main switch 104 may be shared with the node switch associated with the particular child pool. As described more fully below, the particular node switch/child pool may modify one or more settings of the received configuration information to form child pool configuration information independent of the main switch 104 or changing the parent pool configuration information at the main switch 104.

Control for fulfilling the network service may now be deemed to be local or with the particular child pool. Thus, the controller 102 and/or main switch 104 may not be involved in providing the network service unless and until the particular child pool requests involvement (yes branch of block 320). Then the controller 102 and/or main switch 104 may respond to the particular child pool's request at a block 322. Otherwise, the controller 102 and/or main switch 104 waits for an involvement request (no branch of block 320).

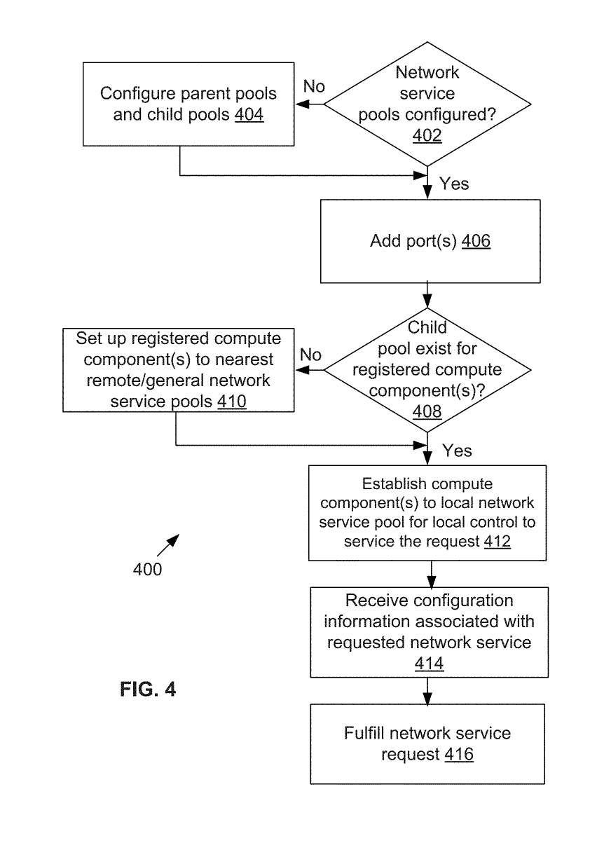

FIG. 4 depicts an example process 400 that may be performed by node switch 114, node switch 124, node switch 134, plug-in 117, plug-in 127, and/or plug-in 137 to discover a registered compute component (such as registered in process 300) and to perform de-centralized network service fulfillment, according to some embodiments. In particular, for the node switch(es) (or associated plug-in(s)) identified by the child pool associated with the network service request, such node switch(es) or plug-in(s) included therein may perform process 400.

In some embodiments, blocks 402 and 404 may be similar to respective blocks 302 and 304 except the pool configuration module 202 included in the node switch(es) identified by the child pool associated with the network service request (or associated plug-in(s)) may be configured to initiate and/or coordinate with the pool configuration module 202 included in the main switch 104 to perform blocks 402 and 404.

If the network service pools may already be configured (yes branch of block 402) or after completion of block 404, then process 400 may proceed to block 406, in which the child pool module 206 included in the node switch(es) (or associated plug-in(s)) may be configured to “add,” enable, actuate, or otherwise ready port(s) of the node switch(es) identified by the child pool associated with the network service request for connection to corresponding port(s) in the main switch 104. The relevant port(s) of the node switch(es) may comprise less than all of the ports allocated in the associated network service pool, such as in the example above in which two of the four allocated ports may be enabled or used rather than necessarily all four of the allocated ports.

Next at a block 408, the pool of compute nodes module 204 included in the node switch(es) (or associated plug-in(s)) identified by the child pool associated with the network service request may be configured to determine whether a child pool exists (from among the plurality of network service pools that exist) for respective compute component(s) that have been discovered (e.g., compute component(s) recently registered such as in process 300). The determination of block 408 may be similar to that discussed in connection with block 308.

When the child pool may not exist (no branch of block 408), then the pool of compute nodes module 204 may be configured to set up, configure, or otherwise establish these discovered compute component(s) to the nearest remote or general network service pools. Such remote or general network service pools may comprise provisionally “attaching” such compute component(s) to pools of generally available compute components without association to the main switch 104 or any compute node switches (node switches 114, 124, 134), at a block 410.

Upon completion of block 410 or if the child pool exists (yes branch of block 408), then process 400 may proceed to block 412. In some embodiments, the child pool module 206 included in the relevant node switch(es) or plug-in(s) may establish a connection, turn on, or “attach” the relevant compute component(s) (those component(s) capable of providing the network service) to the particular child pool, thereby dynamically forming a local network service pool to fulfill the network service request.

Next, at a block 414, parent pool configuration information associated with the requested network service may be received by the node switch(es) associated with the particular child pool. And at block 416, the local network service pool formed in block 412 may fulfill or service the requested network service.

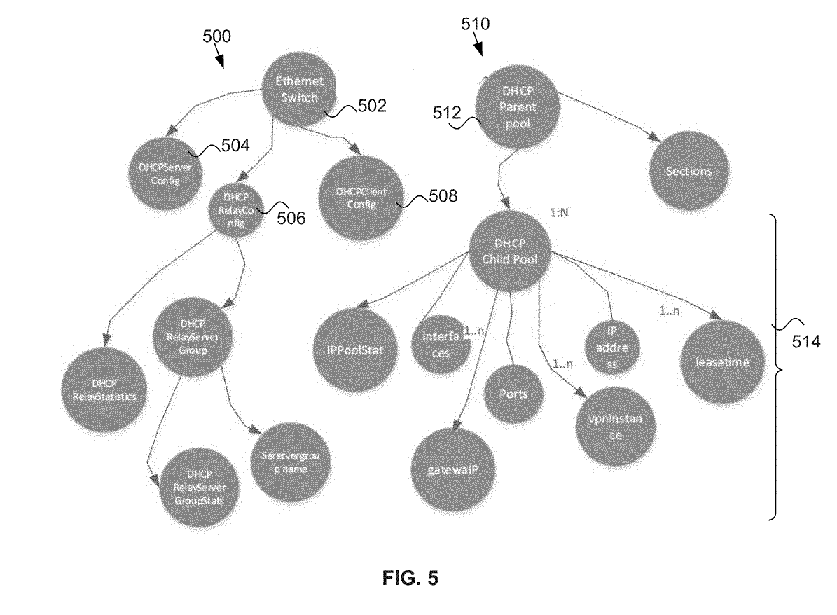

FIG. 5 shows example depictions of different models of DHCP network service pools. A first model 500 may be associated with a conventional DHCP network service pool and second model 510 may be associated with some embodiments of the DHCP network service pool of the present disclosure. In the first model 500, an Ethernet switch 502 may comprise a main switch connected to a network fabric controller (not shown). The Ethernet switch 502 may perform, control, and/or be responsible for a number of functions such as DHCP server configuration 504, DHCP relay configuration 506, and DHCP client configuration 508. And from the DHCP relay configuration 506, in turn, a plurality of other configurations or settings may occur as shown in FIG. 5. In the second model 510, a DHCP parent pool 512 may be associated with a DHCP network service pool at the main switch 104 (e.g., a set of particular port(s) of the main switch 104), which itself may not perform functions to service the DHCP service request. Instead, as shown in FIG. 5, one or more DHCP child pools may perform, control, or be responsible for providing the DHCP service (section 514).

Example DHCP parent pool configuration settings are shown below.
R1(config)# ip dhcp ppool NET-POOL {pool name}
R1(dhcp-config)# subnet 255.255.255.0 {subnet identifier}
R1(dhcp-config)# domain-name ACL.xx {domain name}
R1(dhcp-config)# dns-server 192.168.1.5 8.8.8.8 {DNS server identifier}
R1(dhcp-config)# default-router 19.16.1.1 {default router identifier}
R1(dhcp-config)# lease 9 {lease identifier}

In some embodiments, DHCP child pool configuration settings may be the same as the DHCP parent pool configuration settings. In other embodiments, a child pool may override or modify one or more of the DHCP parent pool configuration settings (modify those settings not excluded from modification) to form DHCP child/local pool configuration settings that are not the same as the corresponding DHCP parent pool configuration settings, such as shown below. In the example below, the DNS server identified in the parent pool settings may not be overridden by the child pool.
R1(config)# ip dhcp cpool NET-POOL {pool name}
R1(dhcp-config)# network 192.168.1.0 255.255.255.0 {network identifier}
R1(dhcp-config)# domain-name CFirewall.xx {domain name}
R1(dhcp-config)# default-router 192.168.1.1 {default router identifier}
R1(dhcp-config)# lease 10 {lease identifier}
R1(config)# ip dhcp excluded-address 192.168.1.1 192.168.1.5 {exclude DNS server}

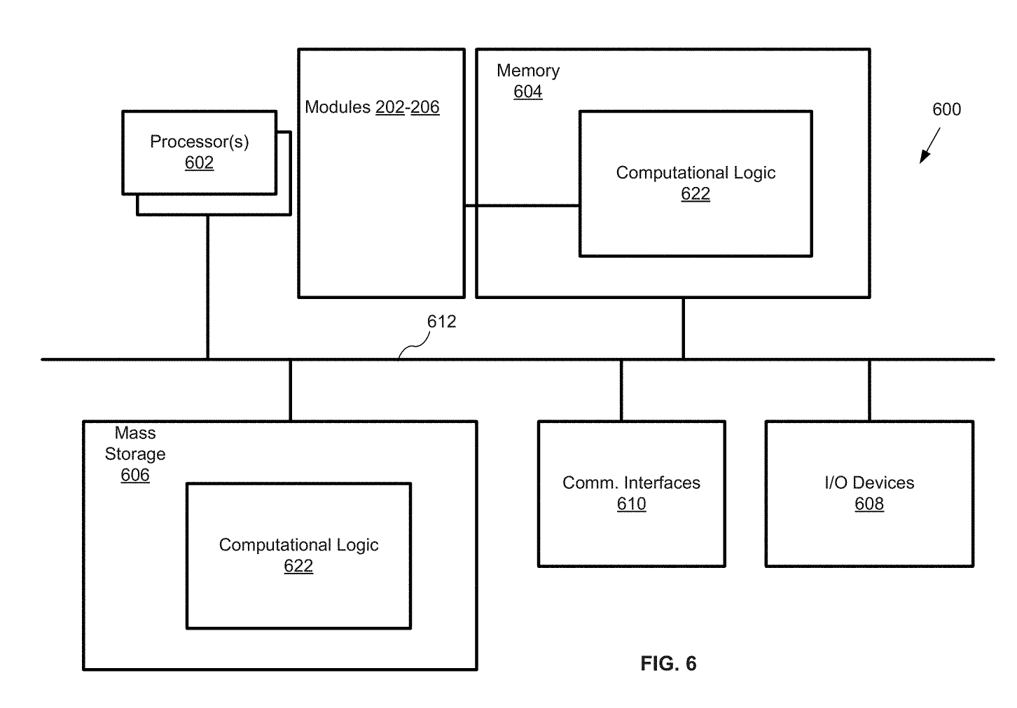

FIG. 6 illustrates an example computer device 600 suitable for use to practice aspects of the present disclosure, in accordance with various embodiments. In some embodiments, computer device 600 may comprise at least a portion of any of the controller 102, main switch 104, node switch 114, node switch 124, node switch 134, compute components 118, compute components 128, and/or compute components 138. As shown, computer device 600 may include one or more processors 602, and system memory 604. The processor 602 may include any type of processors. The processor 602 may be implemented as an integrated circuit having a single core or multi-cores, e.g., a multi-core microprocessor. The computer device 600 may include mass storage devices 606 (such as diskette, hard drive, volatile memory (e.g., DRAM), compact disc read only memory (CD-ROM), digital versatile disk (DVD), flash memory, solid state memory, and so forth). In general, system memory 604 and/or mass storage devices 606 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computer device 600 may further include input/output (I/O) devices 608 such as a microphone, sensors, display, keyboard, cursor control, remote control, gaming controller, image capture device, and so forth and communication interfaces 610 (such as network interface cards, modems, infrared receivers, radio receivers (e.g., Bluetooth)), antennas, and so forth.

The communication interfaces 610 may include communication chips (not shown) that may be configured to operate the device 600 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 610 may operate in accordance with other wireless protocols in other embodiments.

The above-described computer device 600 elements may be coupled to each other via a system bus 612, which may represent one or more buses. In the case of multiple buses, they may be bridged by one or more bus bridges (not shown). Each of these elements may perform its conventional functions known in the art. In particular, system memory 604 and mass storage devices 606 may be employed to store a working copy and a permanent copy of the programming instructions implementing the operations associated with system 100, e.g., operations associated with providing one or more of modules 202-206 as described above, generally shown as computational logic 622. Computational logic 622 may be implemented by assembler instructions supported by processor(s) 602 or high-level languages that may be compiled into such instructions. The permanent copy of the programming instructions may be placed into mass storage devices 606 in the factory, or in the field, through, for example, a distribution medium (not shown), such as a compact disc (CD), or through communication interfaces 610 (from a distribution server (not shown)).

In some embodiments, one or more of modules 202-206 may be implemented in hardware integrated with, e.g., communication interface 610. In other embodiments, one or more of modules 202-206 (or some functions of modules 202-206) may be implemented in a hardware accelerator integrated with, e.g., processor 602, to accompany the central processing units (CPU) of processor 602.

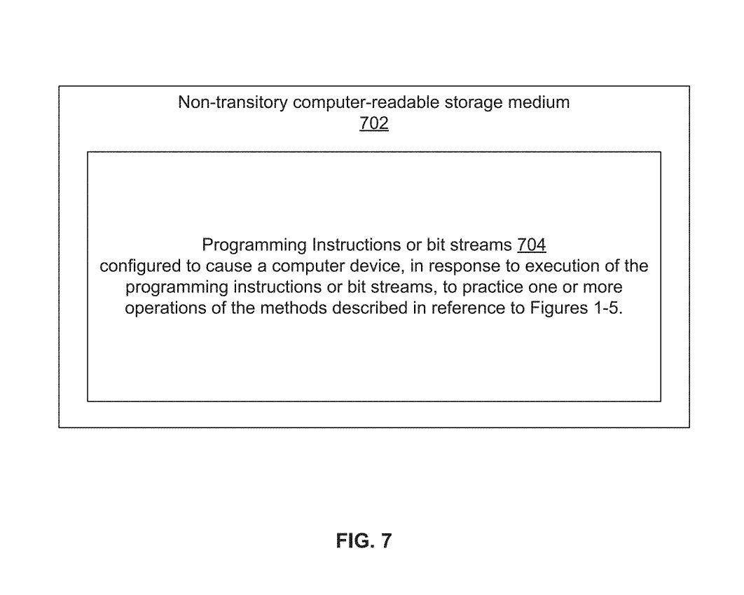

FIG. 7 illustrates an example non-transitory computer-readable storage media 702 having instructions configured to practice all or selected ones of the operations associated with the processes described above. As illustrated, non-transitory computer-readable storage medium 702 may include a number of programming instructions 704 configured to implement one or more of modules 202-206, or bit streams 704 to configure the hardware accelerators to implement some of the functions of modules 202-206. Programming instructions 704 may be configured to enable a device, e.g., computer device 600, in response to execution of the programming instructions, to perform one or more operations of the processes described in reference to FIGS. 1-5. In alternate embodiments, programming instructions/bit streams 704 may be disposed on multiple non-transitory computer-readable storage media 702 instead. In still other embodiments, programming instructions/bit streams 704 may be encoded in transitory computer-readable signals.

Referring again to FIG. 6, the number, capability, and/or capacity of the elements 608, 610, 612 may vary, depending on whether computer device 600 is used as a stationary computing device, such as a set-top box or desktop computer, or a mobile computing device, such as a tablet computing device, laptop computer, game console, an Internet of Things (IoT), or smartphone. Their constitutions are otherwise known, and accordingly will not be further described.

At least one of processors 602 may be packaged together with memory having computational logic 622 (or portion thereof) configured to practice aspects of embodiments described in reference to FIGS. 1-5. For example, computational logic 622 may be configured to include or access one or more of modules 202-206. In some embodiments, at least one of the processors 602 (or portion thereof) may be packaged together with memory having computational logic 622 configured to practice aspects of processes 300, 400 to form a System in Package (SiP) or a System on Chip (SoC).

In various implementations, the computer device 600 may comprise a desktop computer, a server, a router, a switch, or a gateway. In further implementations, the computer device 600 may be any other electronic device that processes data.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein.

Examples of the devices, systems, and/or methods of various embodiments are provided below. An embodiment of the devices, systems, and/or methods may include any one or more, and any combination of, the examples described below.

Example 1 is an apparatus including a network management fabric controller that includes a first module that is to register and configure a compute component capable of providing a network service within a network without association to a main network switch or any compute node switches of the network; a second module, in response to a request for the network service, that is to identify a child pool included in a particular network service pool, from among a plurality of network service pools associated with respective network services, that is capable of providing the network service, the child pool comprising identification of one or more particular ports of a particular compute node switch within the network; and a third module that is to establish a connection between the compute component and the one or more particular ports of the particular compute node switch and between the one or more particular ports of the particular compute node switch and one or more particular ports of the main network switch in accordance with the particular network service pool.

Example 2 may include the subject matter of Example 1, and may further include wherein the particular network service pool includes the child pool and a parent pool, wherein the parent pool comprises identification of one or more particular ports of the main network switch.

Example 3 may include the subject matter of any of Examples 1-2, and may further include wherein the first module is to determine the plurality of network service pools prior to registration and configuration of the compute component.

Example 4 may include the subject matter of any of Examples 1-3, and may further include wherein the second module is to identify the child pool by determining whether the child pool is available to provide the network service based on status information provided by the particular compute node switch.

Example 5 may include the subject matter of any of Examples 1-4, and may further include wherein the second module is to identify the child pool by searching, when the child pool is determined to be unavailable to provide the network service, for an another child pool in nearest proximity to the child pool that can provide the network service, and wherein the network management fabric controller is to establish a connection between the another child pool and the compute component.

Example 6 may include the subject matter of any of Examples 1-5, and may further include wherein the first module is to provide configuration information associated with the network service to the child pool and, absent a request from the child pool, refrain from involvement in fulfillment of the network service.

Example 7 may include the subject matter of any of Examples 1-6, and may further include wherein the network service comprises a dynamic host configuration protocol (DHCP) network service, a link layer discovery protocol (LLDP) network service, a secure shell (SSH) network service, or a virtual local area network (VLAN) network service.

Example 8 may include the subject matter of any of Examples 1-7, and may further include wherein the network management fabric controller is connected to the main network switch.

Example 9 may include the subject matter of any of Examples 1-8, and may further include wherein the compute component comprises a server, a processor, a memory, a router, a switch, a gateway, a relay, a repeater, or a compute node.

Example 10 is a computerized method including, in response to a compute component to add to a network, configuring, by a network management controller, the compute component associated with a network service within the network without association to a main network switch or compute node switches of the network; in response to a request for the network service, identifying, by the network management controller, a child pool included in a particular network service pool, from among a plurality of network service pools associated with respective network services, that is capable of providing the network service, the child pool comprising identification of one or more particular ports of a particular compute node switch within the network; and establishing, by the network management controller, a connection between the compute component and the one or more particular ports of the particular compute node switch and between the one or more particular ports of the particular compute node switch and one or more particular ports of the main network switch in accordance with the particular network service pool.

Example 11 may include the subject matter of Example 10, and may further include wherein the particular network service pool includes the child pool and a parent pool, wherein the parent pool comprises identification of one or more particular ports of the main network switch.

Example 12 may include the subject matter of any of Examples 10-11, and may further include determining the plurality of network service pools prior to and independent of configuration of the compute component.

Example 13 may include the subject matter of any of Examples 10-12, and may further include wherein identifying the child pool comprises determining whether the child pool is available to provide the network service based on status information provided by the particular compute node switch.

Example 14 may include the subject matter of any of Examples 10-13, and may further include wherein identifying the child pool comprises searching, when the child pool is determined to be unavailable to provide the network service, for an another child pool in nearest proximity to the child pool that can provide the network service, and further comprising establishing a connection between the another child pool and the compute component.

Example 15 may include the subject matter of any of Examples 10-14, and may further include providing configuration information associated with the network service to the child pool and, absent a request from the child pool, refraining from involvement in fulfillment of the network service.

Example 16 may include the subject matter of any of Examples 10-15, and may further include wherein the network service comprises a dynamic host configuration protocol (DHCP) network service, a link layer discovery protocol (LLDP) network service, a secure shell (SSH) network service, or a virtual local area network (VLAN) network service.

Example 17 may include the subject matter of any of Examples 10-16, and may further include wherein the compute component comprises a server, a processor, a memory, a router, a switch, a gateway, a relay, or a repeater.

Example 18 is an apparatus including means for configuring a compute component associated with a network service within a network without association to a main network switch or compute node switches of the network; means for identifying a child pool included in a particular network service pool, from among a plurality of network service pools associated with respective network services, that is capable of fulfilling a request for a network service, the child pool comprising identification of one or more particular ports of a particular compute node switch within the network; and means for establishing a communication pathway between the compute component and the one or more particular ports of the particular compute node switch and between the one or more particular ports of the particular compute node switch and one or more particular ports of the main network switch in accordance with the particular network service pool.

Example 19 may include the subject matter of Example 18, and may further include wherein the particular network service pool includes the child pool and a parent pool, wherein the parent pool comprises identification of one or more particular ports of the main network switch.

Example 20 may include the subject matter of any of Examples 18-19, and may further include means for determining the plurality of network service pools prior to and independent of configuration of the compute component.

Example 21 may include the subject matter of any of Examples 18-20, and may further include wherein the means for identifying the child pool comprises means for determining whether the child pool is available to provide the network service based on status information provided by the particular compute node switch.

Example 22 may include the subject matter of any of Examples 18-21, and may further include wherein the means for identifying the child pool comprises means for searching, when the child pool is determined to be unavailable to provide the network service, for an another child pool in nearest proximity to the child pool that can provide the network service, and further comprising means for establishing a connection between the another child pool and the compute component.

Example 23 may include the subject matter of any of Examples 18-22, and may further include means for providing configuration information associated with the network service to the child pool and, absent a request from the child pool, refraining from involvement in fulfillment of the network service.

Example 24 may include the subject matter of any of Examples 18-23, and may further include wherein the network service comprises a dynamic host configuration protocol (DHCP) network service, a link layer discovery protocol (LLDP) network service, a secure shell (SSH) network service, or a virtual local area network (VLAN) network service.

Example 25 may include the subject matter of any of Examples 18-24, and may further include wherein the compute component comprises a server, a processor, a memory, a router, a switch, a gateway, a relay, a repeater, or a compute node.

Example 26 is one or more computer-readable storage medium comprising a plurality of instructions to cause an apparatus, in response to execution by one or more processors of the apparatus, to configure within a network a compute component associated with a network service without association to a main network switch or compute node switches of the network; in response to a request for the network service, identify a child pool included in a particular network service pool, from among a plurality of network service pools associated with respective network services, that is capable of providing the network service, the child pool comprising identification of one or more particular ports of a particular compute node switch within the network; and establish a communication pathway between the compute component and the one or more particular ports of the particular compute node switch and between the one or more particular ports of the particular compute node switch and one or more particular ports of the main network switch in accordance with the particular network service pool.

Example 27 may include the subject matter of Example 26, and may further include wherein the particular network service pool includes the child pool and a parent pool, wherein the parent pool comprises identification of one or more particular ports of the main network switch.

Example 28 may include the subject matter of Example 27, and may further include wherein the plurality of instructions to further cause the apparatus, in response to execution by the one or more processors of the apparatus, to determine the plurality of network service pools prior to and independent of configuration of the compute component.

Example 29 may include the subject matter of any of Examples 26-28, and may further include wherein to identify the child pool comprises to determine whether the child pool is available to provide the network service based on status information provided by the particular compute node switch.

Example 30 may include the subject matter of any of Examples 26-29, and may further include wherein to identify the child pool comprises to search, when the child pool is determined to be unavailable to provide the network service, for an another child pool in nearest proximity to the child pool that can provide the network service, and further to establish a connection between the another child pool and the compute component.

Example 31 may include the subject matter of any of Examples 26-30, and may further include wherein the network service comprises a dynamic host configuration protocol (DHCP) network service, a link layer discovery protocol (LLDP) network service, a secure shell (SSH) network service, or a virtual local area network (VLAN) network service.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

We claim:

1. An apparatus comprising:
a network management fabric controller that includes a first module that is to register and configure a compute component capable of providing a network service within a network without association to a main network switch or any compute node switches of the network; a second module, in response to a request for the network service, that is to identify a child pool included in a particular network service pool, from among a plurality of network service pools associated with respective network services, that is capable of providing the network service, the child pool comprising identification of one or more particular ports of a particular compute node switch within the network; and a third module that is to establish a connection between the compute component and the one or more particular ports of the particular compute node switch and between the one or more particular ports of the particular compute node switch and one or more particular ports of the main network switch in accordance with the particular network service pool.

2. The apparatus of claim 1, wherein the particular network service pool includes the child pool and a parent pool, wherein the parent pool comprises identification of one or more particular ports of the main network switch.

3. The apparatus of claim 1, wherein the second module is to identify the child pool by determining whether the child pool is available to provide the network service based on status information provided by the particular compute node switch.

4. The apparatus of claim 3, wherein the second module is to identify the child pool by searching, when the child pool is determined to be unavailable to provide the network service, for an another child pool in nearest proximity to the child pool that can provide the network service, and wherein the network management fabric controller is to establish a connection between the another child pool and the compute component.

5. The apparatus of claim 1, wherein the network service comprises a dynamic host configuration protocol (DHCP) network service, a link layer discovery protocol (LLDP) network service, a secure shell (SSH) network service, or a virtual local area network (VLAN) network service.

6. A computerized method comprising:
in response to a compute component to add to a network, configuring, by a network management controller, the compute component associated with a network service within the network without association to a main network switch or compute node switches of the network;
in response to a request for the network service, identifying, by the network management controller, a child pool included in a particular network service pool, from among a plurality of network service pools associated with respective network services, that is capable of providing the network service, the child pool comprising identification of one or more particular ports of a particular compute node switch within the network; and
establishing, by the network management controller, a connection between the compute component and the one or more particular ports of the particular compute node switch and between the one or more particular ports of the particular compute node switch and one or more particular ports of the main network switch in accordance with the particular network service pool.

7. The method of claim 6, wherein the particular network service pool includes the child pool and a parent pool, wherein the parent pool comprises identification of one or more particular ports of the main network switch.

8. The method of claim 6, further comprising determining the plurality of network service pools prior to and independent of configuration of the compute component.

9. The method of claim 6, further comprising providing configuration information associated with the network service to the child pool and, absent a request from the child pool, refraining from involvement in fulfillment of the network service.

10. The method of claim 6, wherein the network service comprises a dynamic host configuration protocol (DHCP) network service, a link layer discovery protocol (LLDP) network service, a secure shell (SSH) network service, or a virtual local area network (VLAN) network service.

11. The method of claim 6, wherein the compute component comprises a server, a processor, a memory, a router, a switch, a gateway, a relay, or a repeater.

12. An apparatus comprising:
means for configuring a compute component associated with a network service within a network without association to a main network switch or compute node switches of the network;
means for identifying a child pool included in a particular network service pool, from among a plurality of network service pools associated with respective network services, that is capable of fulfilling a request for a network service, the child pool comprising identification of one or more particular ports of a particular compute node switch within the network; and
means for establishing a communication pathway between the compute component and the one or more particular ports of the particular compute node switch and between the one or more particular ports of the particular compute node switch and one or more particular ports of the main network switch in accordance with the particular network service pool.

13. The apparatus of claim 12, further comprising means for determining the plurality of network service pools prior to and independent of configuration of the compute component.

14. The apparatus of claim 12, wherein the means for identifying the child pool comprises means for determining whether the child pool is available to provide the network service based on status information provided by the particular compute node switch.

15. The apparatus of claim 14, wherein the means for identifying the child pool comprises means for searching, when the child pool is determined to be unavailable to provide the network service, for an another child pool in nearest proximity to the child pool that can provide the network service, and further comprising means for establishing a connection between the another child pool and the compute component.

16. The apparatus of claim 12, further comprising means for providing configuration information associated with the network service to the child pool and, absent a request from the child pool, refraining from involvement in fulfillment of the network service.

17. The apparatus of claim 12, wherein the compute component comprises a server, a processor, a memory, a router, a switch, a gateway, a relay, a repeater, or a compute node.

18. One or more computer-readable storage medium comprising a plurality of instructions to cause an apparatus, in response to execution by one or more processors of the apparatus, to:
configure within a network a compute component associated with a network service without association to a main network switch or compute node switches of the network;
in response to a request for the network service, identify a child pool included in a particular network service pool, from among a plurality of network service pools associated with respective network services, that is capable of providing the network service, the child pool comprising identification of one or more particular ports of a particular compute node switch within the network; and
establish a communication pathway between the compute component and the one or more particular ports of the particular compute node switch and between the one or more particular ports of the particular compute node switch and one or more particular ports of the main network switch in accordance with the particular network service pool.

19. The computer-readable storage medium of claim 18, wherein the particular network service pool includes the child pool and a parent pool, wherein the parent pool comprises identification of one or more particular ports of the main network switch.

20. The computer-readable storage medium of claim 18, wherein the plurality of instructions to further cause the apparatus, in response to execution by the one or more processors of the apparatus, to determine the plurality of network service pools prior to and independent of configuration of the compute component.

21. The computer-readable storage medium of claim 18, wherein to identify the child pool comprises to determine whether the child pool is available to provide the network service based on status information provided by the particular compute node switch.

22. The computer-readable storage medium of claim 18, wherein to identify the child pool comprises to search, when the child pool is determined to be unavailable to provide the network service, for an another child pool in nearest proximity to the child pool that can provide the network service, and further to establish a connection between the another child pool and the compute component.
